(19) United States
(12) Patent Application Publication
(10) Pub. No.: US 2008/0104410 A1
(43) Pub. Date: May 1, 2008

(54) ELECTRONIC CLINICAL SYSTEM HAVING TWO-FACTOR USER AUTHENTICATION PRIOR TO CONTROLLED ACTION AND METHOD OF USE

(76) Inventors: Daniel R. Brown, Frisco, TX (US); Shalini Pandey, Banglaore (IN); Nancy Kaucher Munoz, Beaverton, OR (US); Rajashekhar B. Gunari, Banglaore (IN)

Correspondence Address: MCANDREWS HELD & MALLOY, LTD, 500 WEST MADISON STREET, SUITE 3400, CHICAGO, IL, 60661, US

(21) Appl. No.: 11/552,823

(22) Filed: Oct. 25, 2006

(51) Int. Cl. H04L 9/00; H04K 1/00

(52) U.S. Cl. 713/182; 713/183; 713/184; 713/186

(57) ABSTRACT

Certain embodiments provide systems and methods for facilitating protected access to clinical information systems, functions, or authorizing clinical documents. Certain embodiments provide a method for providing access to a protected clinical system. The method includes verifying a first form of authentication for access to the protected clinical system. The first form of authentication includes one or more alphanumeric characters entered by a user to access the protected clinical system. The method further includes verifying a second form of authentication for access to a controlled function of the protected clinical system. The second form of authentication includes a personalized physical identifier for the user.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to electronic clinical systems, such as electronic medical record or electronic health record systems. More particularly, the present invention relates to systems and methods for two-factor user authentication in clinical systems, such as electronic medical record or electronic health record systems.

Many controls are being placed on the use of Electronic Medical Record (EMR) or Electronic Health Record (EHR) systems. Part 11 of Title 21 of the Code of Federal Regulations govern acceptance of electronic records and electronic signatures. In order to satisfy compliance with 21 CFR Rule 11, systems will have to use two-factor authentication of a user to perform certain actions, such as prescribing certain drugs and executing a clinical signature or document signature during clinical trails.

Additionally, federal Health Insurance Portability and Accountability Act (HIPAA) regulations govern access to and use of patient identifying information. Any data that is contained in a public database must not reveal the identity of the individual patients whose medical information is contained in the database. Because of this requirement, access to and/or use of any information contained on a medical report or record that could aid in tracing back to a particular individual must be verified to help ensure HIPAA compliance.

HIPAA and Rule 11 concerns, among others, mandate careful authentication of user access. However, such EMR or EHR systems frequently need to operate such that a user cannot log into the system and then later walk away and allow an unauthorized user to perform a controlled action. In addition, a workflow that slows a user's work while providing access control is often not acceptable for use. Thus, there is a need for systems and methods for improved user authentication in a clinical system, such as an EMR or EHR system.

### BRIEF SUMMARY OF THE INVENTION

Certain embodiments provide systems and methods for facilitating protected access to clinical information systems and functions.

Certain embodiments provide a method for providing access to a protected clinical system. The method includes verifying a first form of authentication for access to the protected clinical system. The first form of authentication includes one or more alphanumeric characters entered by a user to access the protected clinical system. The method further includes verifying a second form of authentication for access to a controlled function of the protected clinical system. The second form of authentication includes a physical authentication associated with the user.

Certain embodiments provide an authentication system for use in a protected clinical environment. The system includes a user interface for accepting a first form of authentication from a user. The first form of authentication includes one or more alphanumeric characters entered by a user to access the protected clinical environment. The system also includes an input device for detecting a second form of authentication for access to a controlled function of the protected clinical environment. The second form of authentication includes a personalized non-alphanumeric identifier for the user. The system further includes an authentication subsystem for verifying the first form of authentication and the second form of authentication to provide access to the protected clinical environment.

Certain embodiments provide a computer readable medium having a set of instructions for execution by a computer. The set of instructions includes a first verification routine for verifying a first form of authentication for access to the protected clinical system. The first form of authentication includes one or more alphanumeric characters entered by a user to access the protected clinical system. The set of instructions also includes a second verification routine for verifying a second form of authentication for access to a controlled function of the protected clinical system. The second form of authentication includes a personalized non-alphanumeric identifier for the user.

### BRIEF DESCRIPTION OF SEVERAL VIEWS OF THE DRAWINGS

FIG. 1 illustrates a system for providing electronic access to clinical information in accordance with an embodiment of the present invention.

FIG. 2 illustrates a flow diagram for a method for user authentication in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Electronic clinical systems, such as Electronic Medical Record (EMR) systems, Electronic Health Record (EHR) systems, Picture Archiving and Communication Systems (PACS), Radiology Information Systems (RIS), Cardiovascular Information Systems (CVIS), and/or other clinical information systems, store and organize clinical data for one or more patients and/or clinical facilities. The federal Health Insurance Portability and Accountability Act (HIPAA) restricts patient identifying information that non-authorized personnel may access. Failure to follow HIPAA regulations may result in penalties.

Electronic clinical systems, such as EMR and/or EHR, digitally manage patient records and documents in a central database and/or series of related databases or other data storage. Electronic clinical systems store longitudinal patient records including patient demographics, physician affiliations; track patient directives, medications, history, and allergies; and record methods of treatment and procedures, for example. Such clinical systems may be used to help to replace an ambulatory patient paper chart and help keep a more thorough and accurate record of patient information and procedures in an outpatient setting.

In addition to clinical content, electronic clinical systems may manage office logistics, such as scheduling and registration, finance and collections and health insurance billing. Electronic clinical systems can be capable of interfacing with practice management systems to help manage financial and/or other aspects of a clinical office.

Electronic clinical systems may also serve as a support tool to physicians in their decision making processes by providing links to reference material, such as drug dosage, medical text books, clinical terminology and reminders for follow-up visits and procedures. The systems provide data to support a clinician's educated decision.

In certain embodiments, user access to an EMR, EHR and/or other clinical system is controlled by a two-factor authentication scheme. The two-factor authentication scheme helps ensure that a user who performs a controlled action is the user who is logged into the system. For example, a two-factor authentication scheme may be used on an EMR system where the two factors of authentication are separated in time. For example, a first factor is authenticated upon user access to a system, and a second factor is authenticated later in time directly before a controlled action is executed. As used herein, a controlled action may be any of a plurality of actions that are restricted or controlled based on privacy or confidentiality concerns, legal or regulatory concerns, and/or accuracy concerns, such as drug prescriptions, signing off on charts for clinical trials, accessing patient identification data, and the like.

The first form of authentication includes, for example, one or more alphanumeric characters entered by a user to access the protected clinical system. The first form of authentication may be a login to the system with username and password, for example. That is, the first portion of the authentication represents an item of user knowledge (e.g., a password or passcode). The first portion of the authentication may be performed when the user initially accesses the system, for example.

The second form of authentication is performed directly before the controlled action, for example. The second form of authentication is derived from a characteristic or possession of the user, rather than knowledge of the user, for example. The second form of authentication includes a method to uniquely authenticate the user with something that has a physical embodiment, unlike an alphanumeric identifier that a user or an impersonator could remember for later use. Examples of this second form of identification, which is used for authentication include, but are not limited to, biometrics or a proximity badge. For example, the second form of authentication may be a characteristic that could not be left by the system for another user to use, such as biometrics. As another example, the second form of authentication may include a key-card, a proximity sensor, a radio frequency identifier and/or other form of authentication given to the user for identification.

As an example, a physician logs onto an EMR system with a username and password and uses the EMR system during a patient exam. During the exam, a drug is selected for prescription and electronic or direct fax submission to a pharmacy. When this prescription is signed, perhaps at the end of the exam, the physician is prompted to touch a biometric device. If the identity of the physician touching the device does not match the identity of the user who logged in to the EMR system, the authentication fails.

Thus, certain embodiments provide for a two-factor system of authentication where the entry of the two factors of authentication are separated in time. For example, the first factor of authentication is requested for entry into the system. This authentication is then used to determine, based on certain permissions, what authorization that user has. The second form of authentication involves presentation of a physical object that can be confirmed with an input device before a restricted action occurs in the system. The second form of authentication prevents an unauthorized user from accessing controlled portions of an electronic clinical system if an authorized user logins and then leaves the system unattended. Even if an unauthorized person gains knowledge of the first alphanumeric authentication code, the second authentication helps to ensure that only the authorized person can perform the controlled actions.

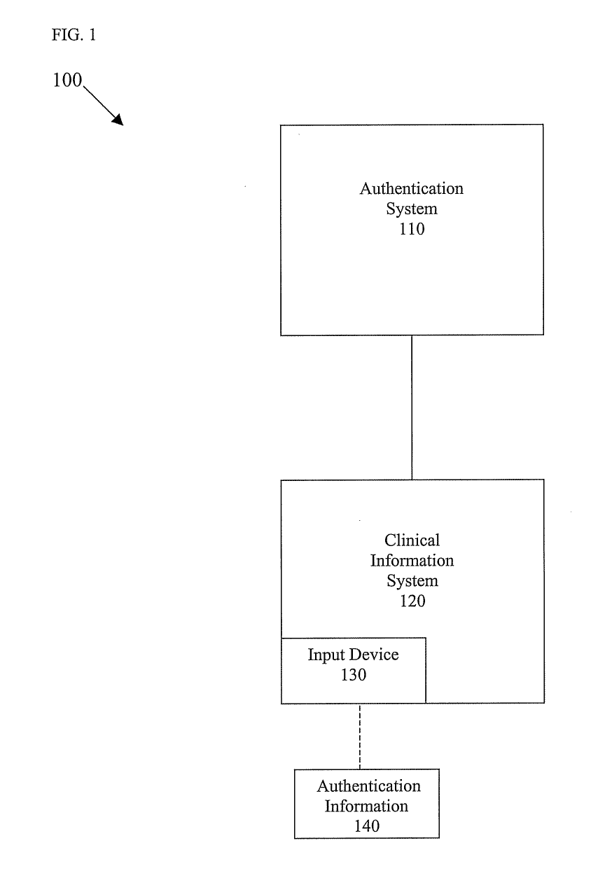

FIG. 1 illustrates a system 100 for providing electronic access to clinical information in accordance with an embodiment of the present invention. The system 100 includes an authentication system 110, a clinical information system 120, an input device 130 and authentication information 140.

The components of the system 100 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain components may be integrated in various forms and/or may be provided as software and/or other functionality on a computing device, such as a computer. For example, the authentication system 110, clinical information system 120 and/or input device 130 may be integrated into a single system. Alternatively, the system 110, system 120 and input device 130 may be implemented separately, for example.

In certain embodiments, user access to an EMR, EHR and/or other clinical system 120 is controlled by a two-factor authentication scheme. The two-factor authentication scheme helps ensure that a user who performs a controlled action is the user who is logged into the clinical information system 120. For example, a two-factor authentication scheme may be used on an EMR system where the two factors of authentication are separated in time.

A first form of authentication is a login to the system 120 with username and password, for example. That is, the first portion of the authentication represents an item of user knowledge (e.g., a password or passcode). The first portion of the authentication may be performed when the user initially accesses the system 120, for example. The user enters a username and password via a keyboard, keypad, touch screen, touch pad, graphical user interface and/or other input device, for example. The username and password information are verified against stored username and password information, such as information stored in a database (e.g., a database in the authentication system 110). If the username and password match stored information, then the user is allowed to access the system 110.

A second form of authentication is performed directly before a controlled action, for example. For example, the clinical information system 120 verifies a second form of authentication prior to prescribing a certain drug or class of drug. The system 120 may prompt a user for a second authentication or may automatically search for and verify the second form of authentication, for example.

In certain embodiments, the second form of authentication is derived from a characteristic or possession of the user, rather than knowledge of the user. For example, the second form of authentication may be a characteristic that could not be left by the system 120 for another user to use, such as biometrics. As another example, the second form of authentication may include a key-card, a proximity sensor, a radio frequency identifier and/or other form of authentication information 140 given to the user for identification. The information system 120 in conjunction with authentication system 110 verifies the authentication information 140 to allow action to the controlled action, for example.

As an example, a physician logs onto an EMR system with a username and password and uses the EMR system during a patient exam. During the exam, a drug is selected for prescription and electronic or direct fax submission to a pharmacy. When this prescription is signed, perhaps at the end of the exam, the physician is prompted to touch a biometric device. If the identity of the physician touching the device does not match the identity of the user who logged in to the EMR system, the authentication fails.

Information for authentication may or may not pass over a network for verification in the system 100. In certain embodiments, authentication information may be transmitted via a network to allow a user to register the first and second authentication information centrally and then be authenticated at a plurality of computers that are connected to a central data source, for example.

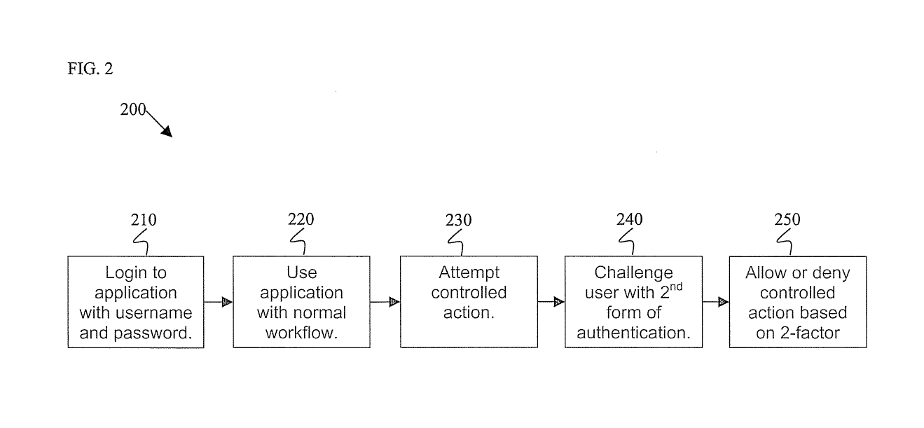

FIG. 2 illustrates a flow diagram for a method 200 for user authentication in accordance with an embodiment of the present invention. At step 210, a user logs in to an EMR management application using a username and password. The username and password are verified against a stored username and password, such as a database, table, list and/or other data storage including username and password information. At step 220, the EMR application is used according to a standard clinical workflow.

At step 230, a controlled action is attempted. For example, a user attempts to access a chart in the EMR application during a clinical trial while this feature is turned on. As another example, a user attempts to access personal identification information for one or more patients via the EMR application. As another example, a user attempts to sign a chart or sign a prescription via the EMR application.

At step 240, a second factor of authentication is requested from the user. For example, the user may be prompted visually and/or audibly for a second form of authentication. Alternatively, the second form of authentication may automatically be checked without prompting the user. In certain embodiments, the second form of authentication is automatically verified but the user is informed that the verification is occurring, for example. The second form of authentication may be biometric authentication (e.g., a fingerprint, palm print, eye scan, voice scan, etc.), for example. Alternatively and/or in addition, the second form of authentication may be a key card, radio frequency identifier, and/or other identification information, for example.

At step 250, a controlled action is allowed or denied based on verification of the second form of authentication. For example, biometric information from the user is verified against stored biometric information to verify that the user is authorized to execute the controlled action. In certain embodiments, third and/or other additional forms of authentication may be required to perform certain actions and/or at certain points in a clinical workflow, for example.

One or more of the steps of the method 200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments provide efficient, often single-touch, systems and methods for authentication without extensive user action. Certain embodiments improve reliability and security of authentication while minimizing impact on workflow. Certain embodiments provide two-factor authentication without requiring a short time-out in the workflow that could be annoying to a user who is attempting to work primarily with patients not the EMR system itself. The two factors of authentication are separated in time to increase reliability and security and to fit into the workflow of the system users. By using a second factor of authentication at the time of a controlled action in addition to a username and password authentication, certain embodiments prove difficult to “spoof” or disguise an unauthorized user.

In certain embodiments, a second form of authentication before a controlled system action may be turned on and off for a system, selectively turned on and off for specific actions in the system and/or may be turned on for a specific action when one or more criterion are met. For example, a physician may be required to submit two-factor authentication for prescribing a drug in one state, for example Texas, where such an action may be required, but on the same system, not required to submit two-factor authentication for prescribing a drug in a different state such as Oklahoma. Additionally, two-factor authentication may be applied to only certain users, certain actions, or all users or actions in the system selectively depending on the system configuration settings.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for providing access to a protected clinical system, said method comprising:
verifying a first form of authentication for access to said protected clinical system, said first form of authentication comprising one or more alphanumeric characters entered by a user to access said protected clinical system; and
verifying a second form of authentication for access to a controlled function of said protected clinical system, said second form of authentication comprising a physical identifier for said user.

2. The method of claim 1, wherein said first form of authentication comprises a username and password.

3. The method of claim 1, wherein said second form of authentication comprises a biometric identification.

4. The method of claim 1, wherein said second form of authentication comprises a card-based identification.

5. The method of claim 1, wherein said verifying of said second form of authentication occurs without prompting said user for said second form of authentication.

6. The method of claim 1, wherein said controlled action comprises at least one of drug prescription, electronic signature of a clinical document, electronic authorization of a clinical document and access to personal identification information for a patient.

7. The method of claim 1, wherein said second form of authentication is verified before execution of said controlled function.

8. An authentication system for use in a protected clinical environment, said system comprising:
a user interface for accepting a first form of authentication from a user, said first form of authentication comprising one or more alphanumeric characters entered by a user to access said protected clinical environment;
an input device for entering a second form of authentication for access to a controlled function of said protected clinical environment, said second form of authentication comprising a personalized physical identifier for said user; and
an authentication subsystem for verifying said first form of authentication and said second form of authentication to provide access to said protected clinical environment or to authorize a clinical document.

9. The system of claim 8, wherein said first form of authentication comprises a username and password.

10. The system of claim 8, wherein said second form of authentication comprises a biometric identification.

11. The system of claim 8, wherein said second form of authentication comprises a card-based identification.

12. The system of claim 8, wherein said verifying of said second form of authentication occurs without prompting said user for said second form of authentication.

13. The system of claim 8, wherein said controlled action comprises at least one of electronically signing or authorizing a clinical document, drug prescription and access to personal identification information for a patient.

14. The system of claim 8, wherein said second form of authentication is verified before execution of said controlled function.

15. The system of claim 8, wherein said protected clinical environment includes at least one of an electronic medical records system, an electronic health records system, a picture archiving and communications system and a radiology information system.

16. A computer readable medium having a set of instructions for execution by a computer, said set of instructions comprising:
a first verification routine for verifying a first form of authentication for access to said protected clinical system, said first form of authentication comprising one or more alphanumeric characters entered by a user to access said protected clinical system; and
a second verification routine for verifying a second form of authentication for access to a controlled function of said protected clinical system, said second form of authentication comprising a personalized non-alphanumeric identifier for said user.

17. The set of instructions of claim 16, wherein said first form of authentication comprises a username and password.

18. The set of instructions of claim 16, wherein said second form of authentication comprises a biometric identification.

19. The set of instructions of claim 16, wherein said second form of authentication comprises a card-based identification.

20. The set of instructions of claim 19, wherein said verifying of said second form of authentication occurs without prompting said user for said second form of authentication.
